(19) United States
(12) Patent Application Publication
(10) Pub. No.: US 2005/0166800 A1
(43) Pub. Date: Aug. 4, 2005

(54) Use of high-absorption-capacity precipitated silica for the production of a colorant by means of impregnation with an inorganic pigment, the colorant thus obtained and the application thereof in the colouring of ceramic materials

(76) Inventor: Gilles Orange, Soisy Sous Montmorency (FR)

Correspondence Address: Jean-Louis Seugnet;Rhodia Inc Intellectual Property Dept, 259 Prospect Plains Road, CN 7500, Cranbury, NJ, 08512-7500, US

(21) Appl. No.: 10/507,238

(22) PCT Filed: Mar. 12, 2003
(86) PCT No.: PCT/FR03/00796

(30) Foreign Application Priority Data
Mar. 12, 2002 (FR) 02/03478

(51) Int. Cl. C08L 95/00; B32B 9/04

(52) U.S. Cl. 106/712; 106/482; 106/275; 501/133; 501/154; 428/446; 428/141

(57) ABSTRACT

The invention relates to the use of precipitated silica having a DOP oil absorption of at least 260 ml/100 g as a raw material in order to produce a colorant by impregnating said silica with an inorganic pigment in the form of a soluble salt and, in particular, with an inorganic pigment based on soluble iron sulphate. The invention also relates to a colorant that can be produced by calcinating and, optionally, grinding a precipitated silica with a DOP oil absorption of at least 260 ml/100 g which has already been impregnated using an inorganic pigment in the form of a soluble salt, such as a soluble iron sulphate-based inorganic pigment. The colorant thus obtained can be used to dye ceramic materials, such as ceramic tiles, and bituminous or hydraulic binding materials.

The present invention relates to the use of precipitated silica with a high absorption capacity, as a starting material for the production of a colorant by means of impregnation of said silica with an inorganic pigment in soluble salt form, in particular with an inorganic pigment based on soluble iron sulfate.

The invention also relates to a colorant that may be obtained by calcination, followed by optional grinding, of a precipitated silica with a high absorption capacity, preimpregnated using an inorganic pigment in soluble salt form, especially an inorganic pigment based on soluble iron sulfate.

The invention also relates to the use of such a colorant for the coloration of ceramic materials, and to the ceramic materials thus coloured.

The invention finally relates to the use of such a colorant for the coloration of materials containing a hydraulic or asphalt binder, and to the materials containing a hydraulic or asphalt binder thus coloured.

Natural or synthetic pigments are used as colorants in the ceramics industry, in particular for the production of coloured traditional roofing tiles and paving tiles. In this case especially, the coloration is performed by adding specific pigments to the ceramic paste before performing by pressing and sintering the roofing tiles/paving tiles obtained.

The standard pigments for ceramics are natural products. Thus, Grés de Thiviers, generally comprising about 90% quartz and about 10% goethite (FeOOH), makes it possible to obtain colours from red to brown, which are the main colours traditionally developed for roofing tiles and especially floor tiles, and in particular the stoneware tiles (Grés Porcellenato) obtained according to a fast-firing process.

However, these natural products, for instance Grés de Thiviers, have a certain number of drawbacks: limited coloration properties, inconsistent reproducibility quality, depletion of the natural resources.

Thus, the ceramics industry is increasingly in search of synthetic pigments (colorants) whose properties are equivalent or superior to those of natural pigments.

A new concept of colorant for ceramic materials has recently appeared: it consists in initially including the pigment in a mineral matrix, more particularly silica. The potential advantage of including the pigment in a vitreous or crystalline inert matrix is the great stability with respect to severe thermal and chemical conditions, such as those encountered in the ceramics industry, and has thus allowed the development of novel colouring powders. Furthermore, in the presence of glazing or sintering, this colorant acts as a chromatic unit from the point of view of pigmentation, and the colour is not developed by introduction of an ion into the network of the matrix or by formation of a solid solution; the crystals responsible for the coloration are, in point of fact, small crystals included during the process of firing/sintering of the matrix.

One application of this novel concept is the synthesis of red/brown inorganic pigments for ceramic applications, by inclusion of hematite (α-Fe₂O₃) into a silica matrix.

F. Bondioli et al. teach (Materials Research Bulletin, Vol. 33, No 5, pp. 723-729, 1998) the use of amorphous fumed silica and of synthetic goethite.

U.S. Pat. No. 6,228,160 describes a red/brown colorant prepared by mixing an iron pigment, a silica-based pulverulent matrix and auxiliary additives such as a silicone oil, said mixing rather being performed in dry form; the colorant in this case is obtained directly without the need to carry out a calcination step.

A colorant manufactured from microsilica (or fumed silica) and iron oxide is described in WO 00/53680: the process involves intensive grinding in wet medium, drying, high-temperature calcination and grinding.

In these processes for manufacturing colouring powder, the mixing between the silica and the iron oxide must be perfect. This implies, for example, that the silica powder must be highly disintegrated by intensive grinding so as to obtain aggregates with a size in the region of or less than that of the iron pigment, i.e. a few microns.

The intensive contact of the silica with the pigment is of great importance in the formation of the colour, in particular the production of a high level of red, high gloss and strong intensity (red/brown after firing). This is particularly the case in the presence of intensive grinding of the constituents.

One of the aims of the present invention is to propose an alternative to the known techniques of the prior art, while at the same time dispensing with an intense grinding step and also making it possible to achieve, in particular, very good calorimetric performance qualities (in particular high stability), and while avoiding the drawbacks mentioned above.

With this aim, a first subject of the invention is the use of high-absorption-capacity precipitated silica, preferably in the form of particles with a mean size of at least 50 μm, as starting material for the production of a colorant by means of impregnation of said silica (which is thus in solid form) with an inorganic pigment in the form of a dissolved soluble salt.

Said inorganic pigment is preferably based on a metallic compound (for example a soluble metal salt) and even more preferably based on an iron compound. This iron compound is generally soluble iron sulfate (iron sulfate solution), soluble iron nitrate (iron nitrate solution) or a mixture thereof.

The precipitated silica used in the context of the invention has a high absorption capacity. Said precipitated silica preferably has a DOP oil uptake of at least 260 ml/100 g, in particular of at least 300 ml/100 g. The DOP oil uptake is determined according to NFT standard 30-022 (March 1953) using dioctyl phthalate.

Said silica is in the form of particles preferably having a mean size of at least 50 μm, in particular at least 80 μm, especially at least 100 μm, for example at least 150 μm, and generally not more than 300 μm or even not more than 250 μm (NF standard X 11507).

Said silica may be in the form of substantially spherical beads, the mean size of which is preferably as indicated above.

The term “precipitated silica” means a silica obtained by precipitation reaction of a silicate, such as an alkali metal silicate (for example sodium silicate), with an acid (for example sulfuric acid); the silica may be precipitated herein by any means: especially, addition of acid to a silicate stock solution, total or partial simultaneous addition of acid and silicate to a stock solution of water or of silicate solution. However, the drying of the cake obtained by filtration of the suspension obtained from the precipitation is preferably performed herein using an atomizer, especially a turbomixing atomizer, or, in particular when it is desired to use a silica in the form of substantially spherical beads, a liquid-pressure or two-fluid nozzle atomizer. The drying may be preceded by an operation of fluidization (disintegration) of the cake. The fluidization operation especially makes it possible to lower, if necessary, the viscosity of the cake to be dried.

The precipitated silica used according to the invention may be prepared, for example, according to preparation processes as described in EP 0 520 862, WO 99/07237 or WO 99/49850.

The precipitated silica used according to the invention may also be a precipitated silica such as the silica Tixosil 38A sold by the Applicant.

The precipitated silica used in the context of the invention preferably has a BET specific surface area of at least 50 m²/g, in particular at least 75 m²/g and especially at least 90 m²/g, for example between 100 and 400 m²/g. It may be between 100 and 250 m²/g and especially between 110 and 250 m²/g.

The BET specific surface area is determined according to the Brunauer-Emmet-Teller method described in “The Journal of the American Chemical Society”, Vol. 60, page 309, February 1938 and corresponding to NF standard T 45007 (November 1987).

In general, 2% to 30%, in particular 5% to 25% and for example 5% to 15% by weight of inorganic pigment may be used relative to the weight of silica+pigment.

The high-absorption-capacity precipitated silica (advantageously amorphous), which is preferably in the form of particles with a mean size of at least 50 μm, may be readily impregnated with the inorganic pigment in the form of a solution (aqueous) of a soluble salt, without any grinding being necessary. A mixer of the Patterson (“y-shaped” mixer), Kenwood, Eirich or Lodige type, or an internal blender of the Brabender type, may be used to impregnate the precipitated silica without grinding.

The impregnated silica obtained is preferably subjected to calcination, optionally after preliminary drying. An addition of silica (in solid form) may be performed.

The calcination is generally performed at a temperature of between 600 and 1300° C., especially between 700 and 1300° C. and preferably between 800 and 1200° C. The calcination may thus be performed at a temperature of between 800 and 1000° C. or at a higher temperature, in the present case between 1000 and 1200° C., depending on the calorimetric parameters desired in the final ceramic material after firing.

The calcination time is preferably at least 30 minutes and in particular at least 45 minutes, for example between 45 and 80 minutes.

The calcination may advantageously be performed at a temperature of between 1000 and 1200° C. for at least 45 minutes, for example for 45 to 80 minutes.

The calcination is usually followed by grinding (or crushing), especially in order to obtain the desired particle size.

A fine powder of colorant is thus obtained, for example having a BET specific surface area of between 10 and 75 m²/g and in particular between 15 and 75 m²/g, for example between 15 and 50 m²/g; it may be between 20 and 50 m²/g and especially between 20 and 40 m²/g.

A subject of the invention is also a colorant (which may be) obtained by calcination, and then optional grinding, of a high-absorption-capacity precipitated silica, which is preferably in the form of particles with a mean size of at least 50 μm, preimpregnated with an inorganic pigment in the form of a dissolved soluble salt.

The preceding description also applies to this subject of the invention.

The colorant according to the invention or derived from the use, according to the invention, of a high-absorption-capacity precipitated silica, which is preferably in the form of particles with a mean size of at least 50 μm, preimpregnated with an inorganic pigment in the form of a dissolved soluble salt, is particularly suitable for colouring ceramic materials, for example sandstone materials, especially stoneware (Grés Porcellenato) materials, on account of its very good calorimetric properties; it gives them, in particular in the case where the initial inorganic pigment used is based on an iron compound, in particular high gloss and high intensity (red/brown). The invention may also make it possible to not use auxiliary additives such as a silicone oil or a silane. Furthermore, it is not necessary to resort to sol-gel type techniques, for instance controlled flocculation of the silica.

The colorant, in powder form, may be mixed with the ceramic paste before performing by pressing and (after optional drying) firing/sintering at high temperature (in particular between 1000 and 1300° C., for example between 1200 and 1250° C.), especially for 20 to 150 minutes, for example between 25 and 70 minutes or between 45 and 90 minutes, of total cycle (coloration in the bulk).

In general, 1% to 10% by weight, for example 2% to 7% by weight, of colorant are used per 90% to 99% by weight, for example 98% to 93% by weight, of ceramic paste (percentage expressed relative to the total weight of colorant+ceramic paste).

The ceramic materials, for example formed from sandstone, especially stoneware, containing at least one colorant as described above constitute one of the subjects of the invention. The calorimetric parameters of said sintered ceramic materials, determined by the CIE method, may be, for example, such that: L<65, especially L<60; a>10 (in particular when the calcination is performed at a temperature of between 1000 and 1200° C., for at least 45 minutes); b>10 (for example, b=19 to 20 for yellow-ochre colours and b=13 to 14 for brick-red colours).

These ceramic materials may especially be roofing tiles, paving tiles, for example stoneware tiles, in particular of red to brown colour when the initial inorganic pigment used is based on an iron compound.

They may also be glazes based on mixtures of oxides, the enamel slip then being deposited on the biscuit before firing (surface coloration).

The colorant according to the invention or derived from the use, according to the invention, of a high-absorption-capacity precipitated silica, which is preferably in the form of particles with a mean size of at least 50 μm, preimpregnated using an inorganic pigment in the form of a dissolved soluble salt (aqueous), is also suitable for colouring materials containing hydraulic or asphalt binder. These materials containing hydraulic or asphalt binder, containing at least one such colorant, also constitute one of the subjects of the invention.

The examples that follow illustrate the invention without, however, limiting its scope.

### EXAMPLE 1

A high-absorption-capacity silica in the form of substantially spherical beads (sold by the Applicant) is impregnated with an iron sulfate solution (proportions: 10% by weight of iron sulfate and 90% by weight of silica (dry equivalent)).

The impregnated silica obtained is dried and then calcined at 1000° C., and then ground so as to obtain a fine powder of colorant.

The colorant thus prepared is introduced into a ceramic paste of sandstone type (Grés Porcellenato), in the following proportions: 4% by weight of colorant and 96% by weight of ceramic paste.

After homogenization, the composition obtained is moistened with 4% by weight of water, formed by pressing and then, after drying, sintered at 1225° C. for 60 minutes (total cycle).

The colorimetric parameters of the sintered ceramic material, determined by the CIE method, are such that: L<65; a>10; 10<b<18.

### EXAMPLE 2

A high-absorption-capacity silica Tixosil 38A (precipitated silica sold by the Applicant) is impregnated with a solution of iron II sulfate (source: Millennium company). The proportions are as follows: 10% by weight of Fe₂O₃ and 90% by weight of silica (dry equivalent) (6.6% iron content).

The iron II sulfate solution is prepared by blending for 30 minutes: 212.5 g of sulfate powder per 100 g of water. The dissolution is facilitated by heating to 55° C.

The silica is then impregnated with this iron sulfate solution in an internal blender (Brabender type) by blending for 25 minutes at 100 rpm. The proportions are as follows: 79.5 g of solution per 100 g of silica in solid form (powder). The product obtained is then dried at 90° C. for six hours. The dried product is screened at 100 microns, so as to remove any aggregates.

The colorant thus prepared is introduced into a ceramic paste of sandstone type (Grés Porcellenato) in the following proportions: 4% by weight of colorant and 96% by weight of ceramic paste.

After aqueous-phase homogenization, followed by drying and deaggregation, the composition obtained is moistened with 4% by weight of water and then formed by pressing so as to obtain pellets. The pellets are then dried at 120° C. (for six hours) and then introduced into a sintering oven. Sintering is performed in a static oven, at 1225° C.-10 minutes, for a total cycle of 60 minutes.

The calorimetric parameters of the sintered ceramic material, determined by the CIE method, are such that: L=57.9; a=10.3; b=17.7.

### EXAMPLE 3

A high-absorption-capacity silica Tixosil 38A (precipitated silica sold by the Applicant) is impregnated with a solution of iron III nitrate (source: Prolabo company). The proportions are as follows: 10% by weight of Fe₂O₃ and 90% by weight of silica (dry equivalent) (6.6% iron content).

The iron III nitrate solution is prepared by blending for 30 minutes: 262.5 g of nitrate powder per 100 g of water. The dissolution is performed at room temperature (21° C.).

The silica is then impregnated with this iron nitrate solution in an internal blender (Brabender type) by blending for 25 minutes at 100 rpm. The proportions are as follows: 145 g of solution per 100 g of silica in solid form (powder). The product obtained is then dried at 90° C. for six hours. The dried product is screened at 100 microns, so as to remove any aggregates.

The colorant thus prepared is introduced into a ceramic paste of sandstone type (Grés Porcellenato) in the following proportions: 4% by weight of colorant and 96% by weight of ceramic paste.

After aqueous-phase homogenization, followed by drying and deaggregation, the composition obtained is moistened with 4% by weight of water and then formed by pressing so as to obtain pellets. The pellets are then dried at 120° C. (for six hours) and then introduced into a sintering oven. Sintering is performed in a static oven, at 12-25° C.-10 minutes, for a total cycle of 60 minutes.

The calorimetric parameters of the sintered ceramic material, determined by the CIE method, are such that: L=49.8; a=14.8; b=15.2.

### EXAMPLE 4

A high-absorption-capacity silica Tixosil 38A (precipitated silica sold by the Applicant) is impregnated with a solution of iron II sulfate (source: Millennium company). The proportions are as follows: 10% by weight of Fe₂O₃ and 90% by weight of silica (dry equivalent) (6.6% iron content).

The iron II sulfate solution is prepared by blending for 30 minutes: 212.5 g of sulfate powder per 100 g of water. The dissolution is facilitated by heating to 55° C.

The silica is then impregnated with this iron sulfate solution in an internal blender (Brabender type) by blending for 25 minutes at 100 rpm.

The product obtained is then dried at 90° C. for six hours, and then calcined in air.

Two tests were performed, with different calcination conditions:
i) at 1020° C. for 60 minutes;
ii) at 1100° C. for 60 minutes.

After calcination, the product is coarsely crushed so as to obtain a fine powder of colorant: the particle size is set by screening at 100 μm.

The colorant thus prepared is introduced into a ceramic paste of sandstone type (Grés Porcellenato), in the following proportions: 4% by weight of colorant and 96% by weight of ceramic paste.

After aqueous-phase homogenization, followed by drying and deaggregation, the composition obtained is moistened with 4% by weight of water and then formed by pressing so as to obtain pellets. The pellets are then dried at 120° C. (for six hours) and then introduced into a sintering oven. Sintering is performed in a static oven, at 1225° C.-10 minutes, for a total cycle of 60 minutes.

The calorimetric parameters of the sintered ceramic material, determined by the CIE method, are such that:

| Calcination | L | a | b |
|---|---|---|---|
| Without (cf Example 2) | 57.9 | 10.3 | 17.7 |
| 1020° C./60 min | 48.4 | 12.6 | 12.3 |
| 1100° C./60 min | 47.8 | 12.3 | 10.7 |

### EXAMPLE 5

A high-absorption-capacity silica Tixosil 38A (precipitated silica sold by the Applicant) is impregnated with a solution of iron III nitrate (source: Prolabo company). The proportions are as follows: 10% by weight of Fe₂O₃ and 90% by weight of silica (dry equivalent) (6.6% iron content).

The iron III nitrate solution is prepared by blending for 30 minutes: 262.5 g of nitrate powder per 100 g of water. The dissolution is performed at room temperature (21° C.).

The silica is then impregnated with this iron nitrate solution in an internal blender (Brabender type) by blending for 25 minutes at 100 rpm.

The product obtained is then dried at 90° C. for six hours, and then calcined in air.

Two tests were performed, with different calcination conditions:
i) at 1020° C. for 60 minutes;
ii) at 1100° C. for 60 minutes.

After calcination, the product is coarsely crushed so as to obtain a fine powder of colorant: the particle size is set by screening at 100 μm.

The colorant thus prepared is introduced into a ceramic paste of sandstone type (Grés Porcellenato), in the following proportions: 4% by weight of colorant and 96% by weight of ceramic paste.

After aqueous-phase homogenization, followed by drying and deaggregation, the composition obtained is moistened with 4% by weight of water and then formed by pressing so as to obtain pellets. The pellets are then dried at 120° C. (for six hours) and then introduced into a sintering oven. Sintering is performed in a static oven, at 1225° C.-10 minutes, for a total cycle of 60 minutes.

The calorimetric parameters of the sintered ceramic material, determined by the CIE method, are such that:

| Calcination | L | a | b |
|---|---|---|---|
| Without (cf Example 3) | 49.8 | 14.8 | 15.2 |
| 1020° C./60 min | 45.8 | 12.9 | 11.6 |
| 1100° C./60 min | 46.3 | 13.3 | 11.2 |

1-26. (canceled)

27. A process for the preparation of a colorant comprising the step of impregnating a high-absorption-capacity precipitated silica, optionally with a mean size of at least 50 μm, with an inorganic pigment in the form of a dissolved soluble salt.

28. The process as claimed in claim 27, wherein said inorganic pigment is based on a metallic compound, optionally an iron compound.

29. The process as claimed in claim 27, wherein said metallic compound is dissolved soluble iron sulfate, or a dissolved soluble iron nitrate.

30. The process as claimed in claim 27, wherein said precipitated silica has a DOP oil uptake of at least 260 ml/100 g and, optionally, of at least 300 ml/100 g.

31. The process as claimed in claim 27, wherein said precipitated silica is in the form of particles with a mean size of at least 50 μm.

32. The process as claimed in claim 27, wherein said precipitated silica is in the form of substantially spherical beads.

33. The process as claimed in claim 27, wherein said precipitated silica has a BET specific surface area of at least 50 m²/g.

34. The process as claimed in claim 27, wherein the impregnated silica obtained is further subjected to calcination and then optionally to grinding.

35. The process as claimed in claim 34, wherein the calcination is performed at a temperature of between 600 and 1300° C.

36. The process as claimed in claim 35, wherein the calcination is performed at a temperature of between 1000 and 1200° C.

37. The process as claimed in claim 34, wherein the calcination is performed during at least 30 minutes.

38. A colorant obtained by calcination, and then optional grinding, of a high-absorption-capacity precipitated silica, preimpregnated with an inorganic pigment in the form of a dissolved soluble salt.

39. The colorant as claimed in claim 38, wherein said inorganic pigment is based on a metallic compound and, optionally, on an iron compound.

40. The colorant as claimed in claim 39, wherein said metallic compound is dissolved soluble iron sulfate, or dissolved soluble iron nitrate.

41. The colorant as claimed in claim 38, wherein said precipitated silica has a DOP oil uptake of at least 260 ml/100 g.

42. The colorant as claimed in claim 38, wherein said precipitated silica is in the form of particles with a mean size of at least 50 μm.

43. The colorant as claimed in claim 38, wherein said precipitated silica is in the form of substantially spherical beads.

44. The colorant as claimed in claim 38 wherein said precipitated silica has a BET specific surface area of at least 50 m²/g.

45. A ceramic material comprising at least one colorant as defined in claim 38.

46. The ceramic material as claimed in claim 45, formed from sandstone.

47. A roofing tile or paving tile, consisting of a ceramic material as defiened in claim 45.

48. A material containing hydraulic or asphalt binder, comprising at least one colorant as defined in claim 38.
